(19) United States
(12) Patent Application Publication
(10) Pub. No.: US 2004/0161509 A1
(43) Pub. Date: Aug. 19, 2004

(54) Harvesting apparatus and method therefor

(76) Inventor: Frank J. Maconachy, Salinas, CA (US)

Correspondence Address: WEISS & MOY PC, 4204 NORTH BROWN AVENUE, SCOTTSDALE, AZ, 85251, US

(21) Appl. No.: 10/619,042

(22) Filed: Jul. 14, 2003

Related U.S. Application Data
(60) Provisional application No. 60/446,645, filed on Feb. 10, 2003.

(51) Int. Cl. A23K 1/00

(52) U.S. Cl. 426/335

(57) ABSTRACT

A self-propelled harvester includes an elongated conveyor belt, over which is positioned a spray chamber. The spray chamber has a plurality of nozzles therein, which are oriented so as to spray produce passing through the spray chamber in a plurality of directions. It is preferred to spray within the spray chamber, in addition to water, a microbicide and a protein. The spray chamber includes a housing, which limits the passage of spray from the nozzles outside of the spray chamber. The housing is intended to limit the passage of non-water spray emissions outside of the spray chamber, and to increase the efficiency of the washing action within the spray chamber.

### RELATED APPLICATION

This non-provisional application claims priority from provisional application No. 60/446,645, filed on Feb. 10, 2003.

### FIELD OF THE INVENTION

This invention relates generally to apparatuses and methods for harvesting produce and, more specifically, to a self-propelled harvester that allows the improved harvesting, washing, and loading of produce.

### BACKGROUND OF THE INVENTION

In the harvesting of certain types of produce, (such as lettuce (including, for example, iceberg lettuce, red beef lettuce, romaine lettuce and cabbage), it is desired to utilize a self-propelled conveyor belt. These travel through the field, with the labor force working along the conveyor. The laborers will harvest the produce, core it, place it on the conveyor, and the conveyor will take it to a trailer that moves through the field in tandem with the harvester. In some versions of a harvester of this type, a washing station of some type can be provided, so that the produce is washed prior to be loaded into the trailer.

The present invention is concerned with a harvesting apparatuses of the self-propelled conveyor type, and that has an improved washing station. The improved washing station is designed to improve the washing process, and also, preferably, to be able to deliver a microbicide and protein to the produce that is being washed.

### SUMMARY OF THE INVENTION

It is an object of the present invention to provide a self-propelled harvester having an improved washing station.

It is a further object of the present invention to provide a self-propelled harvester having an improved washing station, wherein washing of the harvested produce occurs at both the cored and top ends of the harvested produce.

It is a still further object of the present invention to provide a self-propelled harvester having an improved washing station adapted to deliver at least one of a microbicide and a protein to the harvested produce during washing.

It is a yet further object of the present invention to provide a self-propelled harvester having an improved washing station, wherein the washing station includes a housing adapted to substantially contains liquids that are sprayed therein.

### BRIEF DESCRIPTION OF THE DRAWINGS

FIG. 1 is a top view of an embodiment of a self-propelled harvesting aid consistent with the present invention.

FIG. 2 is side view of the harvesting aid of FIG. 1.

FIG. 3 is a perspective view of the spray chamber component of the harvesting aid of FIGS. 1 and 2.

### DETAILED DESCRIPTION OF THE PREFERRED EMBODIMENTS

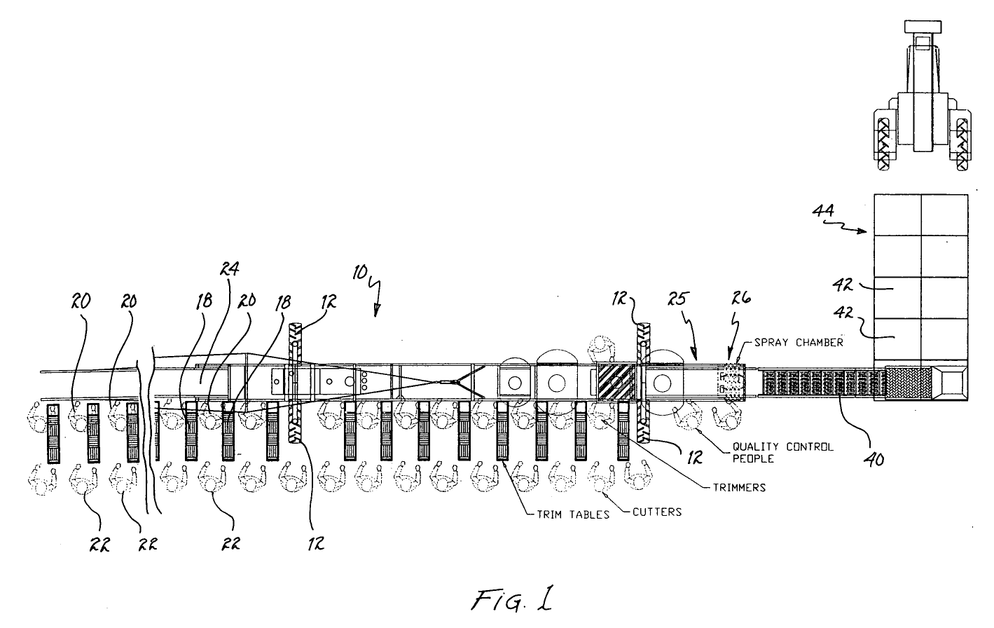

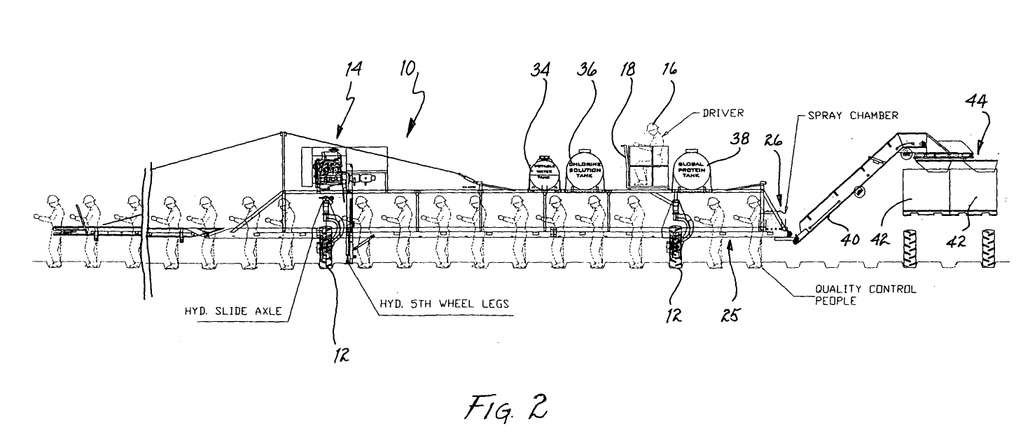

Referring to FIGS. 1 and 2, a harvesting aid 10 (“aid 10”) consistent with the present invention is shown. The aid 10 is elongated and travels on a plurality of wheels 12. The aid 10 is preferably self-propelled, with power being delivered to the wheels 12 from a power source 14. The aid 10 is driven by a driver 16 positioned within a driver station 18.

The wheels 12 are mounted to the aid 10 in a manner permitting them to turn sufficiently so that the aid 10 can be driven in a first direction and then, after turning, in a second direction substantially perpendicular to the first direction. Specifically, it will be desired to drive the aid 10 through a produce field in the direction of the furrows, with the wheels 12 travelling in the furrows 12. When the end of the field is reached, it will be desired to turn the wheels 12 approximately 90 degrees, so that the aid 10 may be positioned for another pass through the field adjacent to the pass that has just been completed. The wheels 12 may then be restored to their prior position for the next pass.

Referring specifically to FIG. 1, a plurality of work tables 18 project outward from the aid 10. These work tables 18 should be spaced far enough apart to permit at least one trimmer 20 to stand therebetween. The surface of the work tables 18, which are expected to come into contact with the harvested produce, should be stainless steel, for greater food safety.

As shown in FIG. 1, behind the trimmers 20 will be a row of cutters 22. The role of the cutters 22 is to cut the produce head from the root. The cutter 22 then places the harvested produce on the work table 18. The trimmer 20 then takes the produce, trims it, and places it on conveyor belt 24, preferably orienting it so that the butt end is exposed. Preferably, this involves placing the produce so that it is on its side, with the butt end proximate the edge of the conveyor belt 24 and the top proximate the interior of the conveyor belt 24. Once on the conveyor belt 24, the produce travels from left to right on FIGS. 1 and 2. The conveyor belt 24 is preferably made of a rubber type material.

Near the terminus of the conveyor belt 24, the produces passes through a quality control station 25. Quality controllers 27 may inspect produce as it passes by along the conveyor belt 24, and remove any produce that appears unfit for further processing.

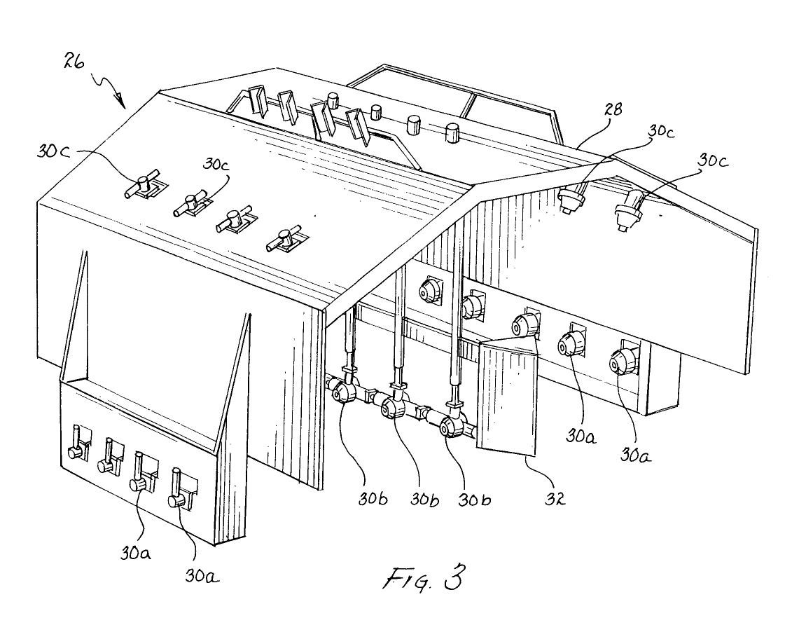

At the terminus of the conveyor belt 24, past the quality control station 25, is located a spray chamber 26, which is shown in detail in FIG. 3. The spray chamber 26 consists of a housing 28, within which are positioned a plurality of spray nozzles 30. The spray chamber 26 further includes, preferably, a diverter 32, which diverts produce to one side or the other of the spray chamber 26. The housing 28 and diverter 32 are preferably of stainless steel for increased food safety.

A first group of the nozzles 30, designated nozzles 30a, are positioned at about the level of the produce, and are positioned to spray from the outside of the housing 28 inward to the center of the conveyor belt 24. A second group of the nozzles 30, designated nozzles 30b, are positioned at about the level of the produce and at the center of the spray chamber 26, so as to spray outward toward the housing 28. A third group of nozzles 30, designated nozzles 30c, are positioned proximate the top of the housing 28, and are positioned to spray downward and toward the middle of the spray chamber 26. As shown in FIG. 3, the third group of nozzles 30c comprise a first sub-group located on one side of the housing 28 and oriented so as to spray toward the middle of the spray chamber 26, and a second sub-group located on the other side of the housing 28 and oriented so as to spray toward the middle of the spray chamber 26. (This configuration is preferred, though it should be noted that it would be possible to located the third group of nozzles 30c proximate an upper, substantially center portion of the inside of the housing 28, and to orient them so that they spray in a downward and potentially also an outward direction.)

The positioning of the nozzles 30, coupled with the trimmer 20's proper placement of the produce on the conveyor belt 24, should permit the spraying of both the butt and top portion of the produce.

The nozzles 30 are adapted to spray a microbicide and a protein. The microbicide, which is preferably a chlorine solution, is provided within a tank 36, preferably located on a top portion of the aid 10. The protein is preferably ICIN 600B manufactured by Global Protein Products. It is provided within a tank 38, also preferably located on a top portion of the aid 10.

It can be seen that the housing 28 acts to contain the spray from the nozzles. This has at least two beneficial effects. First, to the extent that spray from a nozzle 30 is able to pass an item of produce passing through the housing 28, reflect off of a surface of the housing 28, and then return to strike produce that is passing therethrough, a washing machine type of effect is created and the intensity of the wash is therefore increased. In addition, the presence of a housing 28 limits the ability of the spray to be disseminated outside of the area of the spray chamber 26 and potentially onto a worker, and thus permits the use of materials such as microbicides in the washing process that preferably should not be used in a spray environment that lacks a covering.

After passing through the spray chamber 26, the produce enters an elevator 40. The elevator 40 transports the produce upward, and to a position from where it can be placed in a bin 42 on a trailer 44, or other desired location.

For rinsing of the harvesting aid 10 after use, potable water is provided within a tank 34, preferably located on a top portion of the aid 10.

The harvesting aid 10 is particularly suited for use with romaine, though it could be utilized with other produce as well, including other types of lettuce and cabbage.

We claim:

1. A harvesting aid comprising, in combination:
an elongated conveyor belt; and
a spray chamber station positioned along said elongated conveyor belt;
wherein said spray chamber comprises:
a housing positioned over said elongated conveyor;
a first group of nozzles positioned at a height that is about level with said produce as it travels along said elongated conveyor and oriented so as to spray said produce from a side of said housing inward toward a center of said elongated conveyor belt;
a second group of nozzles positioned at a height that is about level with said produce as it travels along said elongated conveyor and oriented so as to spray said produce from a center of said spray chamber toward said housing; and
a third group of nozzles positioned proximate a top of said housing and oriented so as to spray downward and toward said center of said spray chamber.

2. The harvesting aid of claim 1 a quality control station positioned along said elongated conveyor belt prior to said washing station.

3. The harvesting aid of claim 1 wherein said housing has a stainless steel surface.

4. The harvesting aid of claim 1 further comprising a diverter located at a substantially center portion of said spray chamber proximate a surface of said elongated conveyor and adapted to divert produce to one of two areas within said spray chamber.

5. The harvesting aid of claim 4 wherein said diverter has a stainless steel surface.

6. The harvesting aid of claim 1 further comprising a tank, having a microbicide therein, in communication with at least one of said first, second and third group of nozzles.

7. The harvesting aid of claim 1 further comprising a tank, having a protein therein, in communication with at least one of said first, second and third group of nozzles.

8. The harvesting aid of claim 1 wherein said third group of nozzles comprises a first sub-group located on one side of said housing and oriented so as to spray toward a middle portion of said spray chamber, and a second sub-group located on a second side of said housing and oriented so as to spray toward said middle of said spray chamber.

9. A harvesting aid comprising, in combination:
an elongated conveyor belt;
a quality control station positioned along said elongated conveyor belt prior to said washing station;
a spray chamber station positioned along said elongated conveyor belt;
wherein said spray chamber comprises:
a housing positioned over said elongated conveyor;
wherein said housing has a stainless steel surface;
a diverter located at a substantially center portion of said spray chamber proximate a surface of said elongated conveyor and adapted to divert produce to one of two areas within said spray chamber;
wherein said diverter has a stainless steel surface.
a first group of nozzles positioned at about a level of said produce as it travels along said elongated conveyor and oriented to as to spray from a side of said housing inward toward a center of said elongated conveyor belt;
a second group of nozzles positioned at about a level of said produce as it travels along said elongated conveyor and oriented so as to spray from a center of said spray chamber toward said housing;
a third group of nozzles positioned proximate a top of said housing and oriented so as to spray downward and toward said center of said spray chamber;
wherein said third group of nozzles comprises a first sub-group located on one side of said housing and oriented so as to spray toward a middle portion of said spray chamber, and a second sub-group located on a second side of said housing and oriented so as to spray toward said middle of said spray chamber;
a first tank, having a microbicide therein, in communication with at least one of said first, second and third group of nozzles; and
a second tank, having a protein therein, in communication with at least one of said first, second and third group of nozzles.

10. A method for washing harvested produce comprising the steps of:
providing a harvesting aid comprising, in combination:
an elongated conveyor belt; and
a spray chamber station positioned along said elongated conveyor belt;
wherein said spray chamber comprises:
a housing positioned over said elongated conveyor;
a first group of nozzles positioned at a height that is about level with said produce as it travels along said elongated conveyor and oriented so as to spray said produce from a side of said housing inward toward a center of said elongated conveyor belt;
a second group of nozzles positioned at a height that is about level with said produce as it travels along said elongated conveyor and oriented so as to spray said produce from a center of said spray chamber toward said housing; and
a third group of nozzles positioned proximate a top of said housing and oriented so as to spray downward and toward said center of said spray chamber;
placing harvested produce on said elongated conveyor belt;
said harvested produce traveling on said elongated conveyor belt through said spray chamber; and
spraying said harvested produce through said first, second and third groups of nozzles.

11. The method of claim 10 further comprising the steps of:
providing a quality control station positioned along said elongated conveyor belt prior to said washing station; and
conducting a quality control inspection from said quality control station for producing passing along said elongated conveyor belt.

12. The method of claim 10 wherein said housing has a stainless steel surface.

13. The method of claim 10 further comprises the steps of:
providing a diverter located at a substantially center portion of said spray chamber proximate a surface of said elongated conveyor; and
said diverter diverting produce to one of two areas within said spray chamber.

14. The method of claim 13 wherein said diverter has a stainless steel surface.

15. The method of claim 1 further comprising the steps of:
providing a tank, having a microbicide therein, in communication with at least one of said first, second and third group of nozzles; and
spraying said microbicide through said first, second and third groups of nozzles.

16. The method of claim 1 further comprising the steps of providing a tank, having a protein therein, in communication with at least one of said first, second and third group of nozzles; and
spraying said protein through said first, second and third groups of nozzles.

17. The method of claim 1 wherein said third group of nozzles comprises a first sub-group located on one side of said housing and oriented so as to spray toward a middle portion of said spray chamber, and a second sub-group located on a second side of said housing and oriented so as to spray toward said middle of said spray chamber.

18. The method of claim 10 further comprising the steps of:
coring said produce prior to placing it on said elongated conveyor belt; and
positioning said cored produce on said elongated conveyor belt on a side of said produce, so that a butt end of said produce is located proximate an edge of said elongated conveyor belt and a top portion of said produce is located proximate an interior portion of said elongated conveyor belt.
